(19) United States
(12) Patent Application Publication
(10) Pub. No.: US 2011/0245740 A1
(43) Pub. Date: Oct. 6, 2011

(54) Medical shockwave apparatus

(76) Inventors: Pavel Novak, Stetten/SH (CH); Helmut Garrelt Neuland, Kronberg Im Taunus (DE)

(21) Appl. No.: 13/009,477

(22) Filed: Jan. 19, 2011

(30) Foreign Application Priority Data
Jan. 19, 2010 (DE) DE 202010001176.0

(51) Int. Cl. A61H 23/00

(52) U.S. Cl. 601/107

(57) ABSTRACT

The invention relates to a shockwave apparatus for treating the human or animal body by mechanical shockwaves.

### FIELD OF THE INVENTION

The present invention relates to a shockwave apparatus for treating the human or animal body by mechanical shockwaves.

### BACKGROUND OF THE INVENTION

Apparatuses for the treatment by mechanical shockwaves are known, in particular in the field of lithotripsy. There, body concrements, in particular, stones in the body tissue, are disintegrated by focused mechanical shockwaves. Besides the production by electrical discharges in water, apparatuses have been developed producing the mechanical shockwaves by the collision of an accelerated projectile and an impact body and coupling said shockwaves to body tissue by means of said impact body. Such apparatuses have been used in lithotripsy by a direct contact between the impact body or a probe connected to the impact body and the stone, as well as in other treatments of biological body substances. In particular, the treatment of muscle diseases and of diseases in the transition region between muscles and bones are to mentioned. For this purpose, the apparatuses have been applied in an extracorporal manner and the shockwaves have been coupled to the body by pressing the apparatus onto the skin. An example of this can be found in EP 0 991 447.

Another example for a lithotripter constructed rather similarly with respect to the shockwave generation can further be found in EP 0 317 507. Herein, a long thin probe for an insertion into the ureter is provided, having a diameter of 1 mm and length of 500 mm, a distal end of which probe shall come into contact with for instance a kidney stone, while the apparatus housing remains outside of the body.

### BRIEF SUMMARY OF THE INVENTION

The present invention has the object to provide a mechanical shockwave apparatus having an extended field of application.

Hereto, an apparatus having a moveable projectile and an impact body is provided, wherein the shockwaves can be generated and coupled to the body by accelerating the projectile and colliding it with the impact body, and having a housing, in which the projectile and the impact body are mounted and from which a part of said impact body provided for an insertion into the body projects, characterized in that the part of the impact body projecting from the housing has a length of 30 mm to 350 mm and has, along a distal main part of this length, a diameter of 10 mm at maximum and of 2 mm at minimum, as well as an advantageous method of using it according to claim 10.

Preferred embodiments are provided in the dependent claims and are explained more in detail below, wherein the individual features can be relevant for the invention in different combinations and relate to both categories of claims.

The basic idea relates to the design of the impact body, namely of that element, with which the “ballistically” moved projectile collides for the shockwave generation and which couples the generated shockwave into the body to be treated. This relates to the geometry of a part of the impact body projecting from the apparatus housing, in which the projectile and the impact body are mounted and housed. This part is provided for an application of the shockwaves and shall, according to the invention, have a length of 20 mm to 350 mm. This length is significantly larger than the one of impact body front parts projecting typically only a few millimeters from the housing in case of conventional apparatuses, which are provided for an extracorporal application by contacting the skin. Therewith, the apparatus is particularly suited for an insertion into the body. A lower limit of the length of the impact body part projecting from the housing is preferably 40 mm, 50 mm, 60 mm, 70 mm, 80 mm, 90 mm or 100 mm. On the other hand, the apparatus shall not have a probe being as long as in case of a lithotripter. Preferably, the upper limit is 340 mm, 330 mm, 320 mm, 310 mm, 300 mm, 290 mm, 280 mm, 270 mm, 260 mm or 250 mm.

At the same time, the impact body part shall be slightly thicker than the lithotripter probe mentioned, namely have a diameter of at least 2 mm along a distal, that is on the body side, main part of the length projecting from the housing. Therein, the main part amounts to the half at minimum, preferably to 60%, 70% or 80% of the length at minimum. Further, “diameter” simply means the diameter in case of a circular cross-section, however, in a more general sense, it means a typical lateral dimension in case of non-circular cross-sectional shapes, namely the mean value of the largest and the smallest lateral dimension occurring. In case of an elliptical cross-section, this would for instance be the arithmetic mean of the two principal axes considered with their whole length respectively, in case of a rectangle, the mean value of the shortest side and the diagonal.

On the other hand, the same diameter along the mentioned main part of the length shall not be larger than 10 mm.

The lower limit for the diameter is preferably 3 mm or 4 mm, the upper limit is preferably 9 mm, 8 mm or 7 mm.

With this geometry, intracorporal applications besides lithotripsy can advantageously be conducted, namely treatments of bones and preferably of cartilage, both being for instance reachable by a puncture in the body surface, also with the aid of an instrument like a trocar. The mentioned length of the impact body part projecting is sufficient for reaching such regions and, on the other hand, is significantly smaller and thus more convenient in handling than the length of about 500 mm typically occurring in case of impact bodies of lithotripters.

In particular, treatments other than the lithotripsy do not involve destroying the structure, upon which the front face of the impact body is placed, so that larger front face dimensions help avoiding an excessive concentration of the shockwave energy and improve the coupling efficiency. Overall, the respective dimensioning of the impact body part projecting thereby provides a very advantageous combination for intracorporal treatments of bones and cartilage as well as of other biological structures, which shall not be destroyed themselves.

According to a preferred embodiment, the impact body is integral. This relates at least to a part extending from the impact region for the projectile to the exit face for the body contact. In contrast to the part projecting from the housing, which has been discussed so far, this comprises yet another part, which is usually inside of the housing. On the other hand, this part extending integrally does not necessarily account for the whole cross-section of the impact body. In particular, outer structures for fixing, for instance in an elastic mounting, could be attached. Preferably, however, the whole cross-section of the part to be inserted into the body to be treated, that is the cross-section of the distal main part of the impact body, is integral, namely extending preferably at least with the same cross-section up to the impact region for the projectile. This integral embodiment is at least advantageous with respect to the efficiency of the shockwave transfer within the respective impact body and also with respect to manufacturing.

Conventional impact bodies are usually made of stainless steel or so-called special steel. Also in the present context, this material is advantageous and preferred. In general, metallic impact bodies are preferred, but also ceramic ones. Besides stainless steel, in particular titanium and the ceramics zirconium oxide, silicon nitride and silicon oxide are taken into account. As regards the improvements and material properties of ceramic impact bodies, reference is made to EP 08 003 840.9.

The above statements on the diameters to be chosen and preferred according to the invention for the part of the impact body projecting from the housing are of course achievable in a preferable and particularly easy way, if the impact body has a constant diameter along the length projecting from the housing or at least along a significant part thereof. Preferably, this constant diameter is present along at least 30% of the length projecting from the housing and, in this order more preferred, along at least 40%, 50%, 60%, 70%, 80% or 90% of this length.

On the other hand, the preferred option of a constant diameter can also be expressed by a total length, which respectively lies within the limits indicated already in an increasingly preferred order, namely between 20 mm and 350 mm or, in the most preferred case, between 100 mm and 250 mm, wherein the above-mentioned intermediate values shall apply here, too.

As known from the prior art as such, the impact body can be mounted elastically in the housing. In the context of the present invention, a relatively stiff mounting is preferred, namely of a kind allowing a longitudinal travel of 1 mm at maximum, wherein an upper limit of 0.9 mm, 0.8 mm, 0.7 mm, 0.6 mm or 0.5 mm is increasingly preferred. Therein, these values relate to a measurement during a free running operation (without the impact body front face contacting another body) and with a fixed housing, namely while eliminating a recoil movement of the housing as far as possible. Due to the relatively stiff mounting and the consequently short travel, a good contact between the impact body front face and the bone or cartilage treated is given on the one hand. Namely, in contrast to the body skin surfaces treated with apparatuses for the extracorporal treatment known from the prior art, these body substances are relatively stiff and thus compensate less motional distance by their inherent elasticity.

In the context of this invention, it can be practical and preferred, to design the part of the impact body projecting from the housing in a curved manner, in particular in an approximately circular manner. In certain applications, the impact body front face can in this way be placed upon the cartilage, the bone or another body part to be treated within the body more advantageously. Therein, an angular range spanned by the arc of between 10° and 50° is taken into account, wherein 15°, 20° or 25° are increasingly preferred as a lower limit and 45°, 40° or 35° as an upper limit. Therein, the term “length” of the part of the impact body projecting from the housing relates to the arc length and not to a straight line. In this way, the term shall be basically understood in the context of the present description and of the claims. Therein, in case of doubt, the relevant line for the length measurement shall be given by a center of the cross-section of the impact body.

The pneumatic drives suggested in the prior art cited already at the beginning of the description are also preferred and practical in the present context. Here, reference can be made to the explanations in the prior art. However, also different drives are possible, for instance piezoelectric, electromagnetic or drives with magnetostriction.

The same applies for the design of an apparatus according to the invention as a handheld device. Accordingly, at least the impact body, the projectile and the housing are components of a hand piece to be moved and handled by a user's hand. Additionally, a base station can be provided, with which the hand piece can for instance be connected by a pneumatic or other supply line. The base station could comprise a compressor, control electronics and others.

Preferred methods of using the apparatus relate to the treatment of cartilage tissue, in particular articular cartilage. Therein, symptoms to be treated can be caused by rheumatism and/or wear. For instance, arthrosis is contemplated.

In the following, an exemplary embodiment is explained, which serves for an illustration of the invention by various details. The individual features can also be relevant for the invention in a different connection.

### BRIEF DESCRIPTION OF THE DRAWINGS

FIG. 1 shows a shockwave apparatus known from prior art.

FIG. 2a shows a longitudinal section of an alternative impact body for it and thus a first exemplary embodiment.

FIG. 2b shows a second exemplary embodiment having a curved impact body, which, besides that, corresponds to that of FIG. 2.

FIG. 3 shows an inset for the end cap 2a, both together for an assembly of the impact body of FIG. 2 in the shockwave apparatus according to FIG. 1.

### DETAILED DESCRIPTION OF THE INVENTION

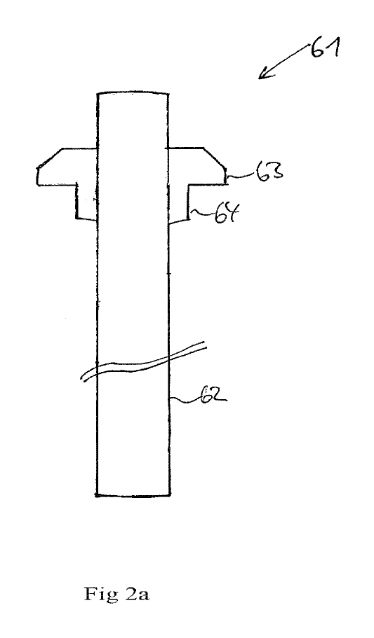

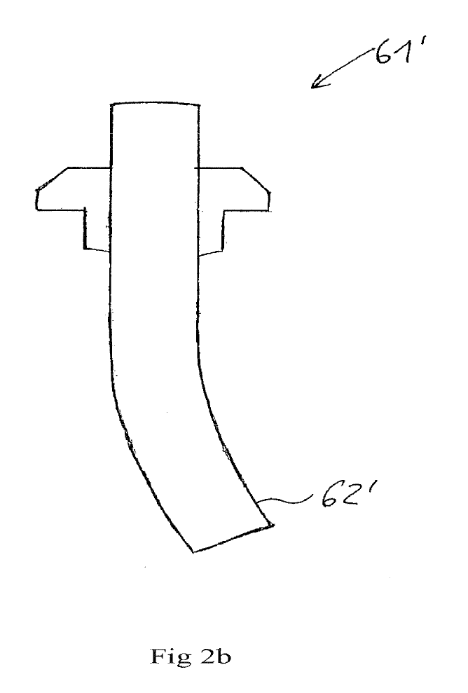

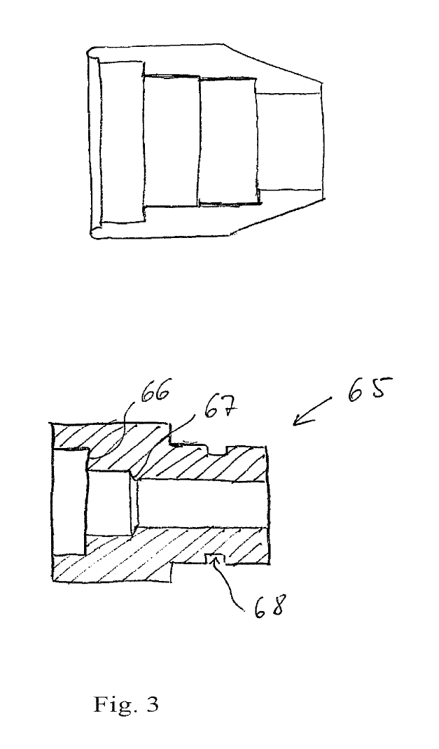

The figure shows a medical apparatus, referenced as a whole by 10, for treating the human body by mechanical shockwaves, namely in this case a conventional apparatus for treating soft tissue in the context of a pain therapy. Modifications according to the invention are explained based on the FIGS. 2a, 2b and 3.

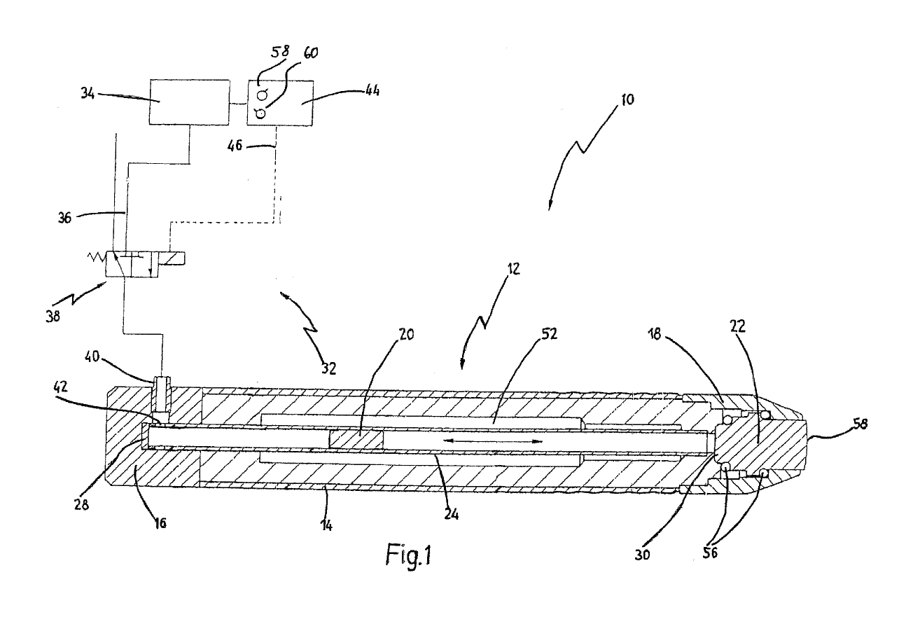

The apparatus of FIG. 1 consists of a hand piece 12 and a pneumatic pressurized gas supply device 32 explained in more detail below. For instance a treating physician can grab the hand piece 12 and place it upon an appropriate skin portion with the right end in FIG. 1, wherein the hand piece 12 is approximately perpendicular to the skin.

A housing 14 is provided with a proximal end cap 16 and a distal end cap 18, which are respectively designed detachable. A guiding tube 24 is supported within the housing and is arranged axially and concentrically therein. A projectile 20 is guided in the guiding tube, a movement path of which along the interior space of the guiding tube 24 is restricted by an impact body 22 on the right side, namely by its proximal face 30. This forms a distal stop for the projectile 20, wherein the proximal stop of the projectile 20 is referenced by 28 and forms a simple close of the guiding tube 24. This close is magnetic, such that the projectile 20 can be secured there with a certain retention force. Typically, the length of the guiding tube 24 is about 15 cm to 20 cm.

The pneumatic drive 32 represents the pressurized gas supply device and comprises a pneumatic compressor 34, which covers a typical operating range of up to about 10 bar, wherein only about up to 5 bar or up to 8 bar are required in many cases. A pressurized gas connection 40, which is in fluid communication with the guiding tube 24 via an opening 42 therein, of the hand piece 12 is supplied via a pressure line 36 and a switching valve 38. The switching valve 38 can be a magnetic valve. A control 44 is connected therewith by a control line 46, which is shown dashed. The control 44 can be designed as a unit with the compressor 34 and thereby form a base unit for supplying the hand piece 12, wherein the switching valve 38 is advantageously provided at the latter. Accordingly, the control 44 and the compressor 34 are connected by a line in FIG. 1. The base unit and the hand piece 12 are then connected by a supply line combining the pneumatic line 36 and the control line 46.

Two adjusting knobs 58 and 60 are provided at the control 44, with which the supply pressure provided by the line 36 and the working frequency of the switching valve 38 can be adjusted. The adjusting knob 58 serves for an adjustment of the outlet pressure of the compressor 34 by the aid of a control circuit in the control 44.

Further, the control 44 is adapted in such a way that it drives the switching valve 38 with a frequency in a range from 0 Hz to 50 Hz, adjusted at the adjusting knob 60.

Starting from an inactive state of the apparatus 10, namely at a beginning of the operation, the shut switching valve 38 is opened by the control 44. The state shown in FIG. 1, in which the guiding tube 24 is connected with the ambient atmosphere, is thereby altered into a state, which is shown by the right box of the valve symbol, wherein the supply pressure is applied to the guiding tube 24 via the connect 40. Therein, the projectile 20 is first located at its starting position, which is indicated by 48 in FIG. 1. The pressure built up accelerates the projectile 20 in direction to the impact body, but is relieved yet before the impact by switching back the switching valve 38 and therewith venting the volume in the guiding tube 24 “behind” the projectile 20. The projectile 20 collides with the impact body 22 of which a distal (slightly convex) terminal surface 48 is in contact with the skin of the patient and couples a mechanical shockwave into the body. Therein, the impact body 22 carries out an axial movement due to its elastic mounting by the two elastomer O-rings 56. Immediately after the impact, the projectile 20 moves back. This is supported by a counter-pressure chamber 52, which is connected with the guiding tube 24, namely with its distal end close to the proximal face 30 of the impact body 22, in a manner not shown more in detail here. In this counter-pressure chamber, a counter-pressure is built up by the displacement as a consequence of the movement of the projectile 20, which counter-pressure guides the projectile back to the proximal stop, namely to the magnetic end cap 28, after the impact. The switching valve 38 is switched again after a specific period of time, such that a new trigger process starts. This specific time period amounts, together with the switch-on time of the switching valve 38, to the reciprocal value of the frequency adjusted. Typical impact velocities of the projectile are in range from 5 m/s to 60 m/s, particularly from 5 m/s to 30 m/s.

FIG. 2 shows an impact body according to the invention for the medical shockwave apparatus of FIG. 1. In contrast to the conventional apparatus 12 of FIG. 1, the apparatus according to the invention, namely the apparatus of FIG. 1, is provided with the impact body 61 of FIG. 2a and is primarily adapted for an application within the body and not for an extracorporal application, namely by placing it on cartilage, in particular. Thereto, a geometry adapted for an insertion into the body, for instance through a trocar, is advantageous, wherein the application of a front face, larger than impact body geometries known from prior art for lithotripsy, onto the cartilage prevents injuries and allows a more effective shockwave coupling. The impact bodies 61 shown below are to be understood instead of the impact body 22 of FIG. 1.

The impact body 61 is shown in a longitudinal section in the figure; its longitudinal axis, namely the axis collinear to the direction of motion of the projectile, lies vertically in the projection plane, thus.

The impact body 61 comprises a titanium rod 62 extending integrally, which has a circular cross-section with a diameter of 5 mm and a total length of 230 mm. Thus, the rod 62 is not shown in its total length.

In its upper region in the figure, the impact body 61 further comprises a flange 63 having an edge beveled at the top and a total diameter of 13 mm and, up to the bevel, of 10 mm, respectively. In the figure below, a shoulder having a diameter of 8.3 mm can be seen, which is referenced by 64. Elastic rings, in particular O-rings having a circular bulk material cross-section, can be provided around the rod 62 above the flange 63, namely contacting its shoulder pointing upwards, and around the shoulder 64 below the flange 63, namely contacting its lower shoulder. The impact body 61 is held in the apparatus by these O-rings, wherein it is additionally guided by the radially outermost lateral surface of the flange 63, which is explained in detail below.

The figure already indicates that the rod 62 can be manufactured independently, namely integrally for this embodiment. It is a simple rod portion, thus. The flange 63 and the shoulder 64 can be manufactured separately, for instance as a stainless steel turned part, and also of a different material, can be slipped-on and be fixed, for instance by a brazing solder connection. Naturally, the whole impact body can also be manufactured integrally, turned on a lathe, in particular. However, the two-piece design explained allows manufacturing impact bodies having a different length for different applications and comprising different materials, in particular made of stainless steel, titanium, zirconium oxide, silicon dioxide or silicon nitride, in a particularly easy and economic way. These differ in their elastic properties and masses, thus allowing, besides the adjustment of the pneumatic supply pressure at the apparatus, a certain influence on the generated elastic shockwaves for an apparatus being unchanged apart from that and even without exchanging the projectile.

FIG. 2b shows a variation 61′ of FIG. 2a, wherein the part of the impact body projecting from the housing is curved as an arc around an angle of 30°. Thereby, an easy access is possible for some applications, for instance to the hip joint. The length of the impact body 61′ is drawn shortened in the figure, to point out the curvature shown only symbolically.

The integral embodiment of the rod 62′ and 61′, respectively, allows an unhindered propagation of the elastic shockwave up to the front face pointing downwards in the figure, independent of material junctions, welded joint spots or the like.

FIG. 3 shows an insert 65, with which the impact body 61 of FIG. 2a or the impact body 61′ of FIG. 2b can be mounted in the shockwave apparatus 10 of FIG. 1.

For this purpose, the displayed intermediate piece 65 comprises a three-stepped axial receiving bore. Its first section, being on the left in FIG. 3, extends from the left end of the intermediate piece 65 to a first radial shoulder 66. Thereby, an elastomer-O-ring is supported, namely the one having been mentioned in the second place above. It is located on the shoulder 64 of the impact body, by whose flange 63 it is supported on the other side. The O-ring having been mentioned above in the first place is supported on the left in the same manner as the left O-ring 56 of FIG. 1 and on the right by the flange 63 of FIG. 2.

Accordingly, the shoulder 64 of the impact body 61 projects, in the second following section of the central bore, into the intermediate piece, whereas the rod 62 itself projects through the third section, namely the right one in FIG. 1, from the intermediate piece to the right. The second and the third section of the central bore are separated by an oblique shoulder 67, which is referenced in FIG. 3. The outer lateral surface of the intermediate piece 65 consists basically of two portions, wherein the one on the left in FIG. 3 has a larger and the one on the right a smaller radius. The left portion additionally comprises a groove 68 for receiving an additional O-ring. This portion is inserted into the part of the inner channel of the end cap 18 being distal in FIG. 1, namely into the right part in FIG. 1, and is sealed there by the O-ring just mentioned in the groove 68. Further, it fits radially exactly into the end cap 18. The lateral surface part on the left in FIG. 3 having a larger radius contacts the shoulder, shown in FIG. 1, in the receiving cap 18, namely the shoulder, which supports the right O-ring 56 on the right in FIG. 1. Also in this case, the intermediate piece fits in radial directions exactly into the end cap 18. Apart from the sealing mentioned, no O-rings or other measures for an elastic damping are provided between the receiving cap 18 and the intermediate piece 65. Those are rather provided between the intermediate piece 65 and the impact body 61, as already mentioned.

Further, the front face of the rod 62, being the upper one in FIG. 2a, contacts the guiding tube 24 of FIG. 1 in the same manner as shown for the front face of the impact body 22 on the left of FIG. 1, namely the face 30. Therewith, the intermediate piece 65 forms an easy adaption of the radial dimensions of the impact body 61 of FIG. 2a to the receiving cap 18 of FIG. 1 being accordingly adapted universally.

Analogously, this applies for the second embodiment, namely the impact body 61′ of FIG. 2b.

The impact body 61 can be inserted into the knee joint with its front part, for instance through a trocar, and can be applied on the knee joint cartilage. The coupling of the shockwaves stimulates cells in these regions and triggers processes, which allow a treatment of arthrosis diseases and other indications. In this context, comparably small elastic movements of the whole impact body 61 in its elastic mounting are desirable, for instance between 0.1 mm and 0.8 mm and preferably between 0.1 mm and 0.5 mm.

What is claimed is:

1. An apparatus for treating a human or animal body by mechanical shock waves, having
a moveable projectile,
an impact body, wherein said shock waves can be generated and coupled to said body by accelerating said projectile and colliding said projectile with said impact body,
and a housing, in which the projectile and the impact body are mounted and from which a part of said impact body provided for an insertion into said body projects,
characterized in that said part of said impact body projecting from said housing has a length of 30 mm to 350 mm and has, along a distal main part of said length, a diameter of 10 mm at maximum and of 2 mm at minimum.

2. The apparatus according to claim 1, wherein said impact body comprises a rod extending integrally from an impact region for said projectile to an exit face for a body contact.

3. The apparatus according to claim 1, wherein said impact body consists of at least one of a metal, in particular one of stainless steel and titanium, and a ceramic, in particular one of zirconium oxide, silicon nitride and silicon oxide.

4. The apparatus according to claim 1, wherein said impact body has along a length of at least 30% of said length of said impact body projecting from said housing a constant diameter between 2 mm and 10 mm.

5. The apparatus according to claim 4, wherein said length having a constant diameter is between 30 mm and 350 mm.

6. The apparatus according to claim 1, wherein said impact body is suspended elastically in such a way that, in a free-running operation, said impact body has a longitudinal travel of 1 mm at maximum, preferably of 0.8 mm at maximum and particularly preferred of 0.5 mm at maximum.

7. The apparatus according to claim 1, wherein said part of said impact body projecting from said housing is curved, preferably circular, over an angle between 10° and 50° in total.

8. The apparatus according to claim 1 having an pneumatic drive for said projectile.

9. The apparatus according to claim 1, wherein at least said projectile, said impact body and said housing are components of a handpiece adapted for a movement and handling by a hand of a user.

10. A method of using an apparatus according to claim 1 for a treatment of cartilage tissue, in particular of articular cartilage.

11. The method according to claim 10, wherein said cartilage tissue is reached by a puncture in a body surface.

12. The method according to claim 11, wherein said cartilage tissue is reached by applying a trocar.
